(19) United States
(12) Patent Application Publication
(10) Pub. No.: US 2009/0061173 A1
(43) Pub. Date: Mar. 5, 2009

(54) Manufacturing Method of Fabrics with Colored Stereoscopic Patterns and Fabrics Manufactured Therefrom

(75) Inventors: I-Hung Liao, Touliu (TW); Young-Chin Chen, Touliu (TW); Hsin Yuan Chan, Touliu (TW)

Correspondence Address: CONNOLLY BOVE LODGE & HUTZ, LLP, P O BOX 2207, WILMINGTON, DE, 19899, US

(73) Assignee: Formosa Taffeta Co., Ltd., Touliu (TW)

(21) Appl. No.: 12/200,098

(22) Filed: Aug. 28, 2008

(30) Foreign Application Priority Data
Aug. 28, 2007 (TW) 096131931

(51) Int. Cl. B32B 3/10; B44C 1/22

(52) U.S. Cl. 428/196; 216/95

(57) ABSTRACT

The present invention relates to a manufacturing method of a fabric with colored stereoscopic patterns which comprises providing a fabric having a man-made fiber layer and a natural fiber layer; analyzing the colors of the desired patterns to be printed through color separation, providing a printing board for each color, and printing the desired colored patterns on the natural fiber layer and printing an etching agent on an area outside the colored patterns on the natural fiber layer via the printing boards; and etching the area on the natural fiber layer that is printed with the etching agent, and then removing the etched area of the natural fiber layer without etching the man-made fiber layer, so as to form the colored stereoscopic patterns woven by the natural fibers on the man-made fiber layer.

### FIELD OF THE INVENTION

The present invention relates to the technical field of dyeing and finishing, and more particularly to a manufacturing method of fabrics with colored stereoscopic patterns.

### DESCRIPTION OF THE PRIOR ART

Currently, patterns on fabrics are divided into plane patterns and stereoscopic patterns. The plane patterns are mostly formed by a dyeing and printing process. The dyeing and printing process has the advantage of being rapidly performable and having fixed patterns, but its disadvantage is that it merely forms plane patterns and has no convex stereoscopic effects. A manner for forming plane patterns called “reducing printing” or “burnt-out printing” comprises applying a burnt-out acid agent on a part of the fabric surface through a printing process to remove one of the fibers in the fabric, but an acid resistant fiber remains, so as to form translucent patterns on the fabric, due to different chemical corrosion resistant properties of different fibers in a single-layer interwoven or blended fabric. However, since part of the fibers in the fabric is removed, the fabric will get thinner, and thus, after the thinner fabric is washed repeatedly or used for a long time, the fabric will be easily deformed or the yarns therein will easily fall off.

The process for forming stereoscopic patterns typically comprises an embroidering process, a jacquard process, and an embossing process.

The embroidering process is to additionally embroider desired patterns on a woven fabric by means of a computer embroidering technique. The embroidering process is more costly, and the obtained fabric has filament texture on both surfaces thereof.

One aspect of the jacquard process is “jacquard carving,” in which thicker weft yarns are woven into patterns to be displayed, but not woven into the fabric without the patterns. The finished fabric is shown in FIG. 1. Many unwoven-in yarns (11) are drawn between pattern portions (10a) and pattern portions (10b) of the fabric, so it is required to cut off the unwoven-in yarns (11), for example with scissors, after the weaving process so that only the pattern portions (10a, 10b) remain. Since the jacquard carving process needs a secondary processing, it is relatively more complex and costly. Furthermore, the visual effect of the patterns formed through the jacquard carving process is not as good as that of the embroidery patterns. EP 0825038B1 discloses a method for manufacturing a multicolor synthetic resin product with lace appearance and texture in which different colors are respectively printed on an embossed part, a lace part, and a flanging part of a lace fabric with desired patterns that are already woven on the fabric.

The embossing process is generally done by generating patterns on a fabric by using a copper roller with desired concave and convex patterns carved thereon. For example, in JP2005054323, a fabric with convex patterns is provided. According to the abstract of JP2005054323, the fabric is obtained through the following steps. First, a denim cloth is embossed. Next, the embossed denim cloth is immersed in a decolorizing solution, and the surface of the denim cloth is scratched with fingertips of rubber gloves, so as to generate non-uniform decolorizing effect on the convex patterns. Although the method disclosed in JP2005054323 can generate stereoscopic patterns on the fabrics, the steps of the method are rather complex, and it is merely limited to single color with different color shading, which cannot meet the consumers' demand for colored patterns.

In view of the above disadvantages, a method for forming colored stereoscopic patterns on fabrics without complex processing steps is still needed.

### SUMMARY OF THE INVENTION

The present invention is directed to a manufacturing method of a fabric with colored stereoscopic patterns which includes the following steps:

providing a fabric having a man-made fiber layer and a natural fiber layer;

analyzing colors of desired patterns to be printed through color separation, providing a printing board for each color, and printing the desired colored patterns on the natural fiber layer and an etching agent on an area outside the colored patterns on the natural fiber layer via the printing boards; and

etching the area on the natural fiber layer that is printed with the etching agent, and then removing the etched area of the natural fiber layer without etching the man-made fiber layer, so as to form the colored stereoscopic patterns woven by the natural fibers on the man-made fiber layer.

The method of the present invention can rapidly form colored stereoscopic patterns on a fabric without complex processing steps. The edges of the colored stereoscopic patterns on the obtained fabric have fringes displayed by cutting the natural fibers, and thus, the fabric has a visual effect similar to that of the embroidery patterns.

### BRIEF DESCRIPTION OF THE DRAWING

FIG. 1 is a schematic view of a conventional jacquard carving fabric.

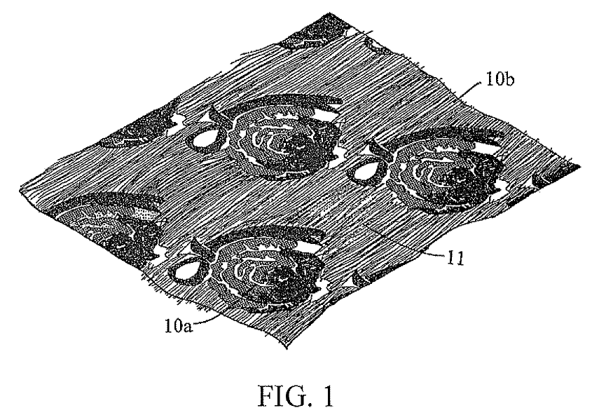

FIG. 2 is a flow chart of a method of the present invention.

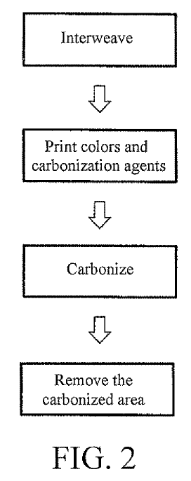

FIG. 3 shows schematic side and plane views of a fabric manufactured by the method of the present invention.

FIGS. 4A and 4B are photos of a fabric with colored stereoscopic patterns obtained by using the method of the present invention.

### DETAILED DESCRIPTION OF THE INVENTION

In the method of the present invention, the natural fiber layer can be made from any natural fibers, including, but not limited to, cotton, hemp, silk, or wool. The man-made fibers can be made from any man-made fibers, including, but not limited to, rayon fiber, nylon fiber, polyester fiber, or acrylic fiber. Preferably, the fabric comprises a back cloth of plain weave and a face cloth of dobby weave.

In the method of the present invention, the color separation of the colored patterns and the manufacturing of the printing board for each color can be performed by utilizing any conventional methods. After the colors of the desired patterns are analyzed through color separation, a printing board of each color is provided, and the printing and coloring step of each color is performed all at once on the same production line by using formulated dye printing pastes.

The etching agent used in the method of the present invention can be any etching agents in the prior art suitable for printing, and comprises a paste (preferably about 5% to about 95%) and an acid mixed at different ratios. Examples of the etching agent include, but are not limited to, an etching agent containing aluminum sulfate, pastes, glycerol, and water, and the viscosity of the etching agent is preferably in a range of about 1,000 to about 50,000 cp. The paste can be any pastes in the prior art suitable for printing, including, but not limited to, starch, soybean paste, starch ether, or cellulose ether. Examples of the paste include, but are not limited to, burn-out paste YT-ME-507 sold by Yee Tien Chemical Enterprise Co., Ltd. or PRINTGEN OP-30PS, KSE-1+H paste available from SENKA Company. The acid can be any acidic chemicals, including, but not limited to, typical sulfuric acid or aluminum sulfate.

In the method of the present invention, the etching step can be performed by means of any conventional techniques. According to a specific embodiment of the present invention, the etching step includes sending the printed fabric to a steamer (FC machine) to be etched at a temperature of about 80° C. to about 250° C. and at a speed of about 5 m/min to about 200 m/min for about 10 sec to 5 min, so that the area of the natural fibers with the etching agent printed thereon is etched due to the corrosion of the etching agent, without etching the man-made fiber layer. It should be noted that, during actual production, in order to carry out the etching process properly, the etching temperature, speed, or time should be adjusted on the basis of such factors as vapor pressure, pattern size, thickness of the fabric, and so on.

Different colors can be printed on the patterns of the fabric by means of any conventional techniques, so that the convex portions of the patterns exhibit beautiful images.

In the method of the present invention, the removing step can be performed by means of any known techniques in the prior art. According to a specific embodiment of the method of the present invention, the removing step includes rinsing the fabric with water or a soap water solution to remove the etched parts of the natural fiber layer, so as to form stereoscopic patterns on the surface of the man-made fiber layer. The rinsing temperature should not be too high, and is preferably about 25° C. to about 135° C. The rinsing time is about 10 min to about 50 min.

The embodiments given below are intended for demonstrating the present invention, not limiting the scope of the present invention. Any modifications and variations that can be easily made by those skilled in the art fall within the scope of the disclosure of the specification and the appended claims of the present invention.

### EXAMPLES

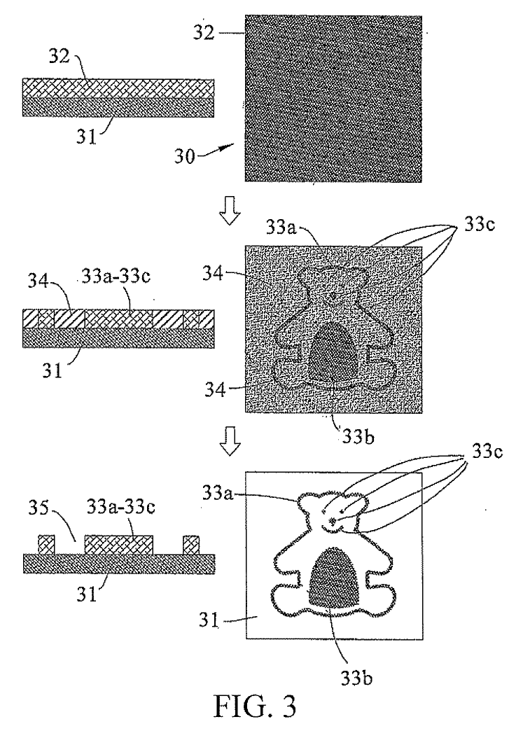

As shown in FIG. 3, a fabric with colored stereoscopic patterns is manufactured according to the following steps:

Interweaving: A double-layer woven fabric (30) is provided, which comprises a man-made fiber layer (31) and a natural fiber layer (32).

Printing colors and etching agents: The colors of desired patterns are analyzed through color separation, and a printing board for each color is provided. The desired colored patterns (33a, 33b, 33c) are printed on the natural fiber layer via the printing boards, and a formulated etching agent containing 40% aluminum sulfate, 35% soybean paste, 5% glycerol, and 20% water is printed on an area outside the colored patterns on the natural fiber layer (32) by using one of the printing boards or another printing board.

Etching: The printed fabric is sent to a streamer (FC machine) and baked at a temperature of about 170° C. for 40 sec, so as to form etched portions (34) on the area of the natural fiber layer with the etching agent printed thereon due to the corrosion of the etching agent. The formulated etching agent merely corrodes the natural fibers, and does not corrode the man-made fibers, thereby retaining the integrity of the pattern portions (33a, 33b, 33c) and the man-made fiber layer (31).

Removing the etched area: The fabric is rinsed with a soap water solution to remove the etched portions (34) of the natural fiber layer (32) and to form graved portions (35) and the pattern portions (33a, 33b, 33c) on the natural fiber layer (32), so that colored stereoscopic patterns woven by the natural fibers are formed on the man-made fiber layer (31).

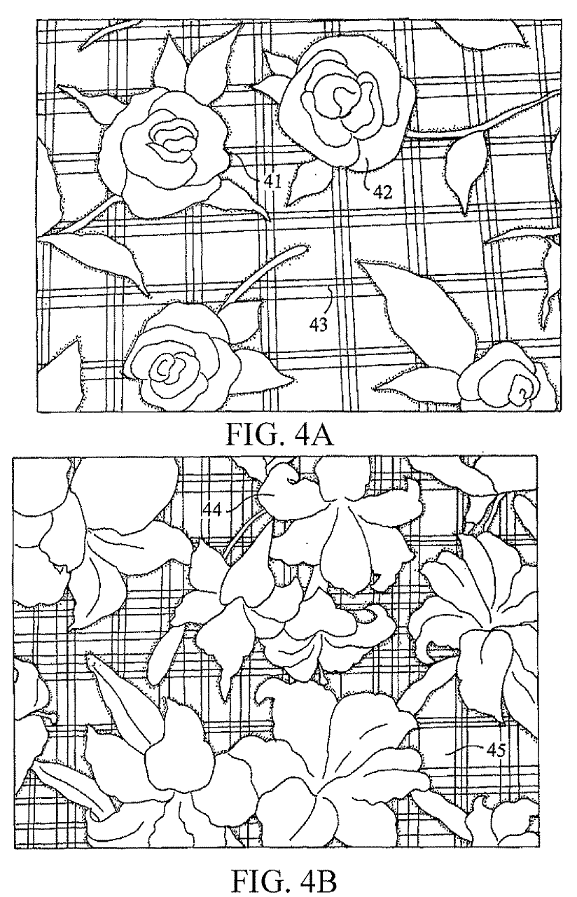

FIGS. 4A and 4B show photos of fabrics with colored stereoscopic patterns manufactured by the method of the present invention. In FIG. 4A, the colored stereoscopic patterns (42) are in the natural fiber layer and the edges of the colored stereoscopic patterns have fringes (41) displayed by cutting the natural fibers, and the area outside the colored stereoscopic patterns is in the man-made fiber layer (43). In FIG. 4B, the colored stereoscopic patterns (44) are in the natural fiber layer, and the area outside the colored stereoscopic patterns is in the man-made fiber layer (45).

The method of the present invention can generate colored stereoscopic patterns woven by natural fibers on the man-made fiber layer of a double-layer woven fabric comprising man-made fibers and natural fibers merely through the steps of printing colors and etching agents, etching, coloring, and removing the etched area. The method does not require a secondary processing, and can significantly speed up the formation of the colored stereoscopic patterns on the fabric (i.e., rapidly manufacturing a fabric with colored stereoscopic patterns) and reduce the cost. Furthermore, the method of the present invention uses a double-layer woven fabric, so that the area of the fabric that has colored stereoscopic patterns (i.e., the pattern portions) is still a structure of a double layer fabric, thereby enhancing the strength and durability of the fabric. Additionally, the edges of the colored stereoscopic patterns of the fabric manufactured by the method of the present invention have fringes displayed by cutting the natural fibers.

What is claimed is:

1. A manufacturing method of a fabric with colored stereoscopic patterns, comprising:
providing a fabric having a man-made fiber layer and a natural fiber layer;
analyzing colors of desired patterns to be printed through color separation, providing a printing board for each color, and printing the desired colored patterns on the natural fiber layer and an etching agent on an area outside the colored patterns on the natural fiber layer via the printing boards; and
etching the area on the natural fiber layer that is printed with the etching agent, and then removing the etched area of the natural fiber layer, but not etching the man-made fiber layer, so as to form colored stereoscopic patterns.

2. The manufacturing method according to claim 1, wherein the natural fiber layer comprises cotton, hemp, silk, or wool.

3. The manufacturing method according to claim 1, wherein the man-made fiber layer comprises rayon fiber, nylon fiber, polyester fiber, or acrylic fiber.

4. The manufacturing method according to claim 1, wherein the fabric comprises a back cloth of plain weave and a face cloth of dobby weave.

5. The manufacturing method according to claim 1, wherein the etching agent comprises a paste and an acid, and has a viscosity of about 100 to about 50,000 cp.

6. The manufacturing method according to claim 5, wherein the etching agent comprises 40% aluminum sulfate, 35% soybean paste, 5% glycerol, and 20% water.

7. The manufacturing method according to claim 1, wherein the etching step is performed at a temperature of about 80° C. to about 250° C., and at a speed of about 5 m/min to about 200 m/min.

8. The manufacturing method according to claim 1, wherein the removing step comprises rinsing the fabric with water or a soap water solution.

9. A fabric with colored stereoscopic patterns obtained by using the manufacturing method according to any one of claim 1, wherein edges of the colored stereoscopic patterns have fringes displayed by cutting the natural fibers.

10. A fabric with colored stereoscopic patterns obtained by using the manufacturing method according to any one of claim 2, wherein edges of the colored stereoscopic patterns have fringes displayed by cutting the natural fibers.

11. A fabric with colored stereoscopic patterns obtained by using the manufacturing method according to any one of claim 3, wherein edges of the colored stereoscopic patterns have fringes displayed by cutting the natural fibers.

12. A fabric with colored stereoscopic patterns obtained by using the manufacturing method according to any one of claim 4, wherein edges of the colored stereoscopic patterns have fringes displayed by cutting the natural fibers.

13. A fabric with colored stereoscopic patterns obtained by using the manufacturing method according to any one of claim 5, wherein edges of the colored stereoscopic patterns have fringes displayed by cutting the natural fibers.

14. A fabric with colored stereoscopic patterns obtained by using the manufacturing method according to any one of claim 6, wherein edges of the colored stereoscopic patterns have fringes displayed by cutting the natural fibers.

15. A fabric with colored stereoscopic patterns obtained by using the manufacturing method according to any one of claim 7, wherein edges of the colored stereoscopic patterns have fringes displayed by cutting the natural fibers.

16. A fabric with colored stereoscopic patterns obtained by using the manufacturing method according to any one of claim 8, wherein edges of the colored stereoscopic patterns have fringes displayed by cutting the natural fibers.
